(19) United States
(12) Patent Application Publication
(10) Pub. No.: US 2020/0223097 A1
(43) Pub. Date: Jul. 16, 2020

(54) VOLUMETRIC MIXER CONTROL SYSTEM

(71) Applicant: Bay-Lynx Manufacturing Inc., Ancaster (CA)

(72) Inventors: Greg Koppelaar, Brantford (CA); Kevin Koppelaar, Ancaster (CA); Ron Dorombozi, Puslinch (CA); Sam Overduin, Brantford (CA); Mark Pennings, Lynden (CA)

(21) Appl. No.: 16/744,124

(22) Filed: Jan. 15, 2020

Related U.S. Application Data
(60) Provisional application No. 62/793,149, filed on Jan. 16, 2019.

(51) Int. Cl. B28C 5/42; G05B 19/05; G05D 1/00; G05D 1/02; G05D 11/13; B60P 3/16

(52) U.S. Cl. CPC B28C 5/422; G05B 19/054; G05D 1/0016; G05D 1/0285; G05B 2219/1101; B28C 5/4231; B60P 3/16; G05D 2201/0202; G05D 11/13

(57) ABSTRACT

A volumetric mixer control system for a mobile volumetric mixer for controlling a mix recipe produced by the mobile volumetric mixer. The control system on the mobile volumetric mixer has a programmable logic controller, electronic control units for controlling flow control devices, and a controller area network for controlling the mixer control system. A mobile electronic device connects the controller area network on the mobile volumetric mixer to a remote terminal for providing a control signal to the mobile electronic device to control the mix produced by the volumetric mixer.

### CROSS-REFERENCE TO RELATED APPLICATIONS

This application claims priority to United States provisional patent application U.S. 62/793,149 filed on 16 Jan. 2019, which is hereby incorporated by reference herein in its entirety.

### FIELD OF THE INVENTION

The present invention pertains to a mobile volumetric and gravimetric mixer control system. In particular, the present mixer control system can provide mix control to modernize and simplify volumetric and gravimetric mixer operation.

### BACKGROUND

Volumetric and gravimetric mixers are used for on-site mixing of a variety of solid and liquid materials. In the concrete industry, volumetric mixers mix cementitious materials with aggregates and liquids to produce hardening concretes. Volumetric and gravimetric concrete mixers contain separate compartments or reservoirs for aggregate such as sand and stone, cementitious materials such as Portland cement, Pozzolanic materials or supplementary cementitious materials such as and fly ash, water, and other characteristic altering additives. One type volumetric mixer is a mobile concrete mixer for on-site mixing or manufacturing and delivery of concrete. Gravimetric measurement can also be used in combination with volumetric methods where weighing of components, in particular solid materials, is used to accurately portion out mix materials. Volumetric mixers are capable of delivering specific, controllable, volumes of accurately mixed material at a constant rate, and can be thought of as mobile plants capable of delivering freshly prepared concrete and other cementitious products of a custom mix design directly at a job site. Non-limiting examples of cementitious products are grout, mortar, concrete of various hardnesses and composition, soil, cement, and specialty formulations of the same.

Mobile volumetric and gravimetric mixers have enabled the use of rapid hardening concretes with initial set times of less than an hour, which is useful in rapid surfacing and repair of roads and highways which require fast drying and hardening times. Other advantages of volumetric mixers compared to traditional drum mixers, wherein pre-prepared concrete is transported to a pour site, are that volumetric mixers can produce batches as small as a quarter of a cubic meter or yard of cementitious product with essentially no wasted material, and the cementitious product can be delivered at any time and is not dependent on the operation of a traditional batch plant. Also, cementitious products are perishable and begin hardening as soon as its components, and particularly the cementitious material, are mixed. With a volumetric mixer the cementitious product is always mixed fresh for each job giving it maximum strength upon setting, and can be delivered on site without worry of premature hardening or damage to alite or belite crystallization. A volumetric mixer precisely meters out cementitious materials, sand, stone, water and other additives on-site such that the cementitious product is poured is the right mix and amount is that is formulated is an accurate reflection of the desired mix design and quantity that the job requires. Specialty mix designs with more or fewer ingredients can also be readily formulated.

Volumetric mixers are complex machines with a variety of hydraulic, electronic and mechanical controls to control the volumetric mixer as well as the vehicle and/or other aspects of the plant. Standard control systems on volumetric mixers comprise a control panel or operator interface in combination with hydraulic and mechanical ratio control systems where an operator can input a concrete mix or recipe, specifying the amounts of each component and desired volume for preparation which is particular to the job. In one example, U.S. Pat. No. 7,386,368 to Andersen describes a method of manufacturing a concrete composition inputting a selection of parameters into a computer system and manufacturing the concrete based on a calculated mix. In another example, U.S. Pat. No. 7,792,618 to Quigley et al. describes a concrete vehicle having control system and a wireless communication system configured to communicate with an off-board electronic device for indicating status information for a plurality of vehicle parameters to an operator. In currently available volumetric mixers, control of the volumetric mixer requires an operator to make intelligent decisions regarding the configuration of the mixer to select the mix recipe and make manual configuration changes to the equipment in order to achieve the necessary mix proportions. For operators with limited training, operating such volumetric mixers can present a challenge both for the operator and for the concrete company calibrating a concrete mix for a job based on multiple functional and environmental factors. In addition, because of the requirement for manual interaction with the mixer, the actual composition created can differ from the intended mix design thus resulting in a needless reduction in overall quality and/or increase in cost.

Accurate volumetric ratioing and measuring in a volumetric mixer control is important for achieving a uniform and predictable quality of dispensed concrete that matches a set and repeatable standard. In one example of volumetric mixer control, U.S. Pat. No. 9,180,605 to Long describes a volumetric concrete mixing system and method utilizing load sensors for measuring weight loss from aggregate and cement bins and a water tank. Local sensors can assist with ensuring accurate measurement of dispensed materials, however more fined tuned control of concrete mix and recipe has the capability of delivering optimized strength concrete tailored for particular jobsites. Typically, volumetric mixers are certified and calibrated offsite to function predictably and accurately at any jobsite vs gravimetric mixers that must be certified and calibrated at a specific location and deployment.

Other advantages of mobile volumetric mixers include the ability to deliver fresh concrete to a jobsite, which is especially important when the jobsite is outside of the typical delivery zone of a traditional batching plant. However mixer dosing, mix recipe design and implementation can be problematic as the operator of the mobile mixer is required to be skilled in the concepts of cementitious product mix design and mixer operation where a traditional drum mixer operator need only be skilled in the delivery of the concrete, and trained operators are generally in short supply. The benchmark mobile volumetric mixers require multiple manual interventions and interactions between the operator and the local mixer control system which creates opportunity for errors to propagate into the system. There can also be a substantial difference between the recipe for a mix design and the real world properties of a pour as influenced by material characteristics. There remains a need for a communication and control system for a volumetric mixer that provides remote mix control of delivered cementitious material.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a certifiable mobile volumetric and gravimetric mixer control system. Another object of the present invention is to provide a mixer control system that can provide mix control to modernize and simplify mobile volumetric and gravimetric mixer operation.

In an aspect there is provided a mobile volumetric mixer control system comprising: a local mixer control system on the mobile volumetric mixer comprising: a plurality of electronic control units for controlling a plurality of flow control devices; a programmable logic controller in electronic communication with the plurality of electronic control units; a transceiver for wireless communication; and a controller area network for communicating with the plurality of electronic control units; a mobile electronic device comprising a transceiver for local wireless communication with the controller area network; a remote terminal for providing a control signal to the mobile electronic device to control the mix produced by the volumetric mixer; and a communication link for bi-directional communication between the remote terminal and the mobile electronic device.

In another aspect there is provided a volumetric mixer control system comprising: a local mixer control system on the volumetric mixer comprising: a programmable logic controller; and a plurality of electronic control units for controlling a plurality of flow control devices; and a controller area network for controlling the mixer control system; a mobile electronic device comprising a transceiver for local wireless communication with the controller area network; a remote terminal for providing a control signal to the mobile electronic device to control the mix produced by the volumetric mixer; and a communication link for bi-directional communication between the remote terminal and the mobile electronic device.

In an embodiment of the control system, at least one of the plurality of electronic control units controls a hydraulic valve, pneumatic valve, or electromechanical actuator.

In another embodiment of the control system, the programmable logic controller stores at least one mix recipe.

In another embodiment of the control system, the programmable logic controller stores calibration data for the volumetric mixer.

In another embodiment of the control system, the plurality of flow control devices are selected from augers, volumetric gates, gravimetric gates, valves, conveyors, gas pumps, scales, and liquid pumps.

In another embodiment, the control system further comprises at least one sensor in communication with the controller area network.

In another embodiment of the control system, the sensor detects at least one of auger torque, feed conveyor torque, gate settings, mass, material flow rates, oil temperature, vibration, external temperature, external humidity, ingredient temperatures, external weather, volumetric mixer location or GPS location, and ingredient moisture content.

In another embodiment of the control system, the remote terminal is a desktop, laptop, tablet, smartphone, or smart electronic device.

In another embodiment of the control system, each of the plurality of flow control devices is a volumetric control device or a gravimetric control device.

In another embodiment of the control system, the communication link is a cellular network or a satellite communication network.

In another embodiment of the control system, the mobile electronic device is a tablet, smartphone, or smart electronic device.

In another aspect there is provided a method of controlling a mobile volumetric mixer, the method comprising: formulating a mix recipe at a remote terminal; generating control data to control the mobile volumetric mixer for the mix recipe sending the control data to a mobile electronic device; sending the control data from the mobile electronic device to the mobile volumetric mixer; and creating a mix composition at the mobile volumetric mixer per the mix recipe.

In another aspect there is provided a method of controlling a volumetric mixer, the method comprising: accessing pour and mix parameters; formulating a mix recipe at a remote terminal based on the pour and mix parameters; generating control data to control the volumetric mixer for the mix recipe; sending the control data to the volumetric mixer; and creating a mix composition per the mix recipe.

In an embodiment, the method further comprises accessing calibration data on the volumetric mixer and adjusting the mix recipe based on the calibration data.

In another embodiment, the method further comprises accessing sensor data and adjusting the recipe based on the sensor data.

In another embodiment, the sensor data comprises at least one of auger torque, feed conveyor torque, gate settings, mass, material flow rates, oil temperature, vibrations, external temperature, external humidity, ingredient temperatures, external weather, volumetric mixer location or GPS location, and ingredient moisture content.

In another embodiment, the pour parameters comprise at least one of volumetric mixer temperature, elevation, GPS location, performance additives, ingredient variations, ambient humidity, weather, precipitation, desired strength, curing characteristics, and mixer functionality and function.

In another embodiment, the method further comprises using machine learning to optimize the mix recipe.

In another embodiment, the mix recipe is updated during the course of creating the mix composition.

In another aspect there is provided a volumetric mixer comprising: an aggregate reservoir with an aggregate flow control device; one or more primary fluid reservoirs with a flow control valve; one or more cementitious material reservoirs with a material flow control device; a mixer control system comprising: a plurality of electronic control units for controlling a plurality of flow control devices; a programmable logic controller in electronic communication with the plurality of electronic control units; a transceiver for wireless communication with a mobile electronic device; and a controller area network for communicating with the plurality of electronic control units; wherein the mobile electronic device provides a control signal to the controller area network to control the mix produced by the volumetric mixer.

In another aspect there is provided a volumetric mixer comprising: an aggregate reservoir with an aggregate control device; a water reservoir with a water control valve; a cement reservoir with a material flow control device; a mixer control system comprising: a programmable logic controller; and a plurality of electronic control units for controlling a plurality of flow control devices; a controller area network for controlling the mixer control system; and a transceiver for establishing a bi-directional communication link between the controller area network and a mobile electronic device, wherein the mobile electronic device provides a control signal to the controller area network to control the mix produced by the volumetric mixer.

In another embodiment, the mobile electronic device is mountable on the volumetric mixer.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is a rear perspective view of a mobile volumetric mixer;

FIG. 2 illustrates an example volumetric mixer control system;

FIG. 3 illustrates a representative mixer mounted control panel;

FIG. 4 illustrates the inside of a representative control box with electro-hydraulic valves;

FIG. 5 illustrates an example of a solids flow gate with controllable height adjustment capability;

FIG. 6A illustrates independently powered powder additive silos to control the flow rate of powders;

FIG. 6B is a side view of a powder aggregate storage bin with transfer augers;

FIG. 7 is a perspective view of independently powered liquid additive storage tanks;

FIG. 8 is a perspective view of a powered fiber additive reservoir;

FIG. 9 is a front view of a powered drive motor for drawing in aggregates from a storage hopper;

FIG. 10 is an example of a primary liquid or water pump;

FIG. 11 is a cutaway view of the drop point of materials into a mixing bowl or funnel before entering a mixing auger;

FIG. 12 is a perspective view of a mixing auger and the discharge end of a volumetric mixer;

FIG. 13 illustrates an example communication dataflow for the mobile volumetric mixer control system;

FIG. 14 illustrates another example volumetric mixer control system;

FIGS. 15A and 15B are example graphical user interfaces for a mobile electronic device application; and

FIG. 16 is an example graphical user interface for a remote terminal.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

As used herein, the term “volumetric mixer” refers to any mobile mixer that mixes solid and liquid materials in a defined ratio. A volumetric mixer can also refer to a mixer having gravimetric controls instead of or in addition to volumetric controls for materials to be ratioed by weight.

As used herein, the terms “cementitious material” and “cement” refer to any binder or substance that sets, hardens, and adheres to other materials to bind them together. Cementitious products are mixtures of cementitious materials and non-cementitious materials such as aggregates, and the cementitious material in the mixture hold everything together as the mixture hardens. Cementitious materials include but are not limited to traditional portland cement, fly ash, ground granulated blast furnace slag (GGBS), limestone fines and silica fume, and can also include or be combined with pozzolanic materials and supplementary cementitious materials.

As used herein, the term “cementitious product” refers to a composite material comprising aggregate, cementitious material, and primary fluid, that hardens upon curing, one example of which is concrete. Cementitious products can be comprised of a wide variety of aggregates in variable sizes and ratios depending on the application, and can also contain other additives such as but not limited to fibers, polymers, adhesives, and binders. Primary fluids can be comprised of one or more fluids including but not limited to water, water-based fluids, latex modified fluids, solvents, solvent-based fluids, epoxies (one part, multipart of equal or unequal dosing), and a combination thereof, optionally comprising soluble additives. Concrete is a type of cementitious product which typically comprises sand, gravel, water, and portland cement as the cementitious material. The term concrete is used herein to refer to the product of the volumetric mixer, however it is understood that other types of non-concrete cementitious products can also be prepared by the volumetric mixer.

As used herein, the term “pour parameters” refers to the set of external conditions at the location and time of the concrete pour or cementitious product preparation. The pour parameters can include but are not limited to: geographical parameters such as location, soil composition, soil humidity, soil temperature, soil depth, and GPS location; environmental parameters such as weather, external temperature, air humidity; and time parameters such as time of year, time of day, age of stored materials, and time since last mixer cleaning. Pour parameters can also include human parameters such as identification of the mixer operator, which includes level of operator experience and operator performance.

Herein is described a volumetric mixer control system for providing improved control of mix and mix recipe design of delivered concrete and other cementitious products. The present system provides integration of an external communication system and control system to a local mechanical control system in a local network on the volumetric mixer to enable remote precision control and automation of the volumetric mixer. The volumetric mixer can a mobile mixer, such as mounted to a truck body or trailer. Volumetric and/or gravimetric means can be used for dosing, formulating and mixing cementitious material by the volumetric mixer control system.

The present system provides tailored cementitious material and concrete mixes, also known as recipes, and orders for each job based on desired concrete characteristics and pour parameters. Pour parameters, calibration data and mix designs can be saved locally and recalled at a later time, or communicated to and from a remote location to optimize the mix based on the job requirements and external parameters. By considering the pour parameters and application and providing a mix recipe for each job to a local volumetric mixer control system, the volumetric mixer senses, doses, and mixes base materials to produce an accurately mixed and controlled pour whose ratios and pour conditions are recorded and are less prone to operator error. Operator error can be human in nature, such as improper or inaccurate adjustment of the settings on the system, or a misidentification of the mix ingredients or their composition. The details of mix recipes and pour parameters can be recorded along with data pertaining to the conditions of the pour, the concrete mixed, and the volume delivered. By remotely providing mix recipe instructions to the local flow control devices on the volumetric mixer, the operator of the volumetric mixer can focus on the physical aspects of the mix or pour job and physical configuration of the volumetric mixer while decisions about mix recipe, fluid dosing and mechanical gating control are automatically provided to the local mixer control system to generate the pour mix. Selection and recalling of the mix recipe and configuration changes to the equipment to achieve the necessary mix proportions can be provided from a remote location, further improving and standardizing the mix control and optimizing the produced cementitious product. Control of the mixer can further be local or remote.

The system is capable of sending actual raw, in progress, and finished material characteristics to a remote terminal for dynamic mix design modification. An adequately controlled system is capable of synthesizing a cementitious product with specific desirable characteristics from base ingredients that might not normally be though capable of such a formulation. The benchmark solution to mobile volumetric mixers requires highly skilled operators to be physically present and active in the operation of the machine, however the present system provides is a new type of control system that allows an operator, either local or remote, to receive dynamic and instantaneous mixer characteristics, pour parameters, and metrics to make active decisions and changes to the equipment parameters remotely. The remote operator could be actively receiving and sending communications with multiple mixers, potentially in different locations around the world, simultaneously. The changes to mixer configuration and mix designs can be saved locally to the mixer and recalled at a later date. The communications technology package can also be expanded to incorporate other business activities such as scheduling, invoicing, dispatch, troubleshooting, data logging etc.

Remote monitoring and calibration of the volumetric mixer can further reduce the need for a skilled operator to be present to ensure the mixer is correctly calibrated and is performing as intended. As such, the skilled volumetric mixer technician can be situated at a site remote from the volumetric mixer, such as in a remote office, and can make specific, deliberate adjustments to the volumetric mixer through a communication link to the local volumetric mixer control system. This skilled operator can also obtain remote sensor readings related to the environmental conditions at the mixing site as well as on-board mixer and mix component properties and configure all physical attributes of the mixer including but not limited to pump and valve settings, material flow rates, mix rates, auger angles, additives and amounts thereof, auger speed, heater temperatures, cooler temperatures, fluids entrapped in aggregates, and running speed of devices. This level of sense and controlling enables more fine attuning of the mix to adjust to the volumetric mixer conditions and pour parameters, thus enabling production of a better mix for the job required, and enabling the local mobile volumetric mixer to adjust the mix based on available data and information. The volumetric mixer can record and communicate back to the remote skilled operator information such as instantaneous vehicular characteristics, chemical mix composition characteristics, and complete job metrics such as total weights, and volumes of ingredients added to a production run or pour. Sensor data collected by sensors located on the mixer to detect various aspects of mixer running can also be sent back to the remote technician to provide early warning of inaccuracies or inefficiencies in mixer operation, or additional information relevant to mixer or mix recipe calibration or mixer optimization. Sensors can detect, for example but not limited to, auger torque, feed conveyor torque, gate settings, mass, fluid flow rates, oil temperature, vibrations, external temperature, external humidity, ingredient temperatures, and ingredient moisture content, which are relevant to operation of the mixer. The volumetric mixer can be operated remotely via internet protocol while also increasing the performance capabilities and pour quality through new levels of control which remove some critical tasks and workload from the onsite operator. The instructions and communications provided to the volumetric mixer can also be affected by an intermediate tool such as a cloud based logic, artificial intelligence (AI) logic, a dispatcher, a team leader, owner operator, or other stake holder. Pattern recognition through machine learning and artificial intelligence based on input sensor data as well as pour parameters, job, and product properties can provide insights into optimal concrete mixes for any given set of pour parameters, and modernization of concrete formulation based on pour parameters will ultimately provide concrete products with higher strength and durability. Machine learning and sensor reporting during the pour can also provide dynamic mix adjustment during the pour to further optimize the mix.

The control system enables and provides two-way communication between the mixer and a remote work station such that the operator at the remote station can read and write changes to the mix design based on direct feedback from the mixer sensors, cameras, LIDAR, engine parameters any information communicated through the CAN bus systems or other control systems or networks. The changes communicated to the mixer from the remote operator terminal will initiate the mixer to dynamically make changes to operational metrics such as pump speed, auger angle, motor speeds, dosing gate settings, etc. to effectively allow the remote operator to control the mixer as if he was physically present and directly controlling. This feedback, optionally in addition to artificial intelligence (AI) augmented feedback, or some combination thereof can also be displayed to the remote operator in real time.

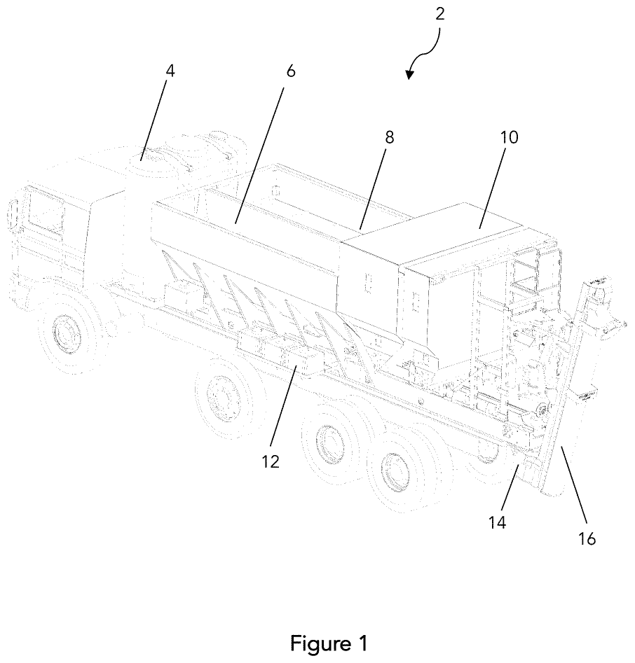

FIG. 1 is an illustration of one example of a mobile volumetric mixer 2. Volumetric mixer units generally consist of reservoirs of base materials including at least one primary fluid storage tank 4, a sand storage bin 6, an aggregate storage bin 8, and at least one cementitious powder storage bin 10. Other storage reservoirs or liquid admixture reservoirs 12 can hold liquid materials such as, for example, binders, colorants, and other additives. Examples of admixtures include but are not limited to colourants, retardants, air entrainment compounds (to increase freeze-thaw durability), water reducers (to achieve different slumps at a lower cement ratio than what is normally designed or increase concrete strength by using less cement), accelerants (to reduce setting time and/or increase the rate of strength development), shrinkage reducers, and liquid additives like latex and superplasticizers. In one example, retarders and fly ash can be added to slow the hydration process. Individual base materials are directed from their individual reservoirs to a funnel 14 which feeds a mixing auger 16 (inside housing). Solid base materials can include aggregates such as but not limited to sand, gravel, and stone, and fibers including but not limited to steel, glass, synthetic, natural, polymeric, and combinations thereof. Manipulation of the amount of each individual ingredient as it is dosed into the mixing auger 16 and control of mass or volume of each added material is supplied and controlled by a gate, pump, auger, conveyor, plunger or other flow control device through the mixer control system. The mixing auger 16 receives the individual materials, then mixes and dispenses the mixture such that the dispensed material is uniform, preferably without entrapped air and adequately wetted and/or partially hydrated, by the time the material leaves the auger.

Automation is controlled locally through a set of electric, electronic, electromechanical, electrohydraulic and electropneumatic systems that interact with the raw materials and mixer hardware to achieve a high quality and consistent chemical composition that is capable of curing into a predictable and repeatable product. The individual components and individual systems on the mixer are interconnected through a mobile control system and can communicate using a controller area network bus (CAN bus) technology, which is a robust message-based protocol typically used in vehicles. The CAN bus system can also control other systems on the truck such as, for example but not limited to, the lubrication system and air circulation system engine, transmission, safety equipment, operator controls, all electronically influenced chassis components. Optional air compressors and air or gas storage tanks can also be fitted on the volumetric mixer to inject air or gasses into any of the reservoirs or mixers as desired. Air separators can also be used to remove condensation in components in the system, lift different components, control metering gates, secure auger hooks, and assist in aeration by, for example, air sweep, pulses, and/or air fluidizers, to keep cementitious powders flowing or manipulate the powder density during dosing, flow, and/or in aggregate powder storage bins. Air separators and compressors can be further timed to go on or off at specified intervals and can also be controlled by the control system. Air can also be used to control aggregate vibrators.

The presently described volumetric mixer with mixer control system can used to make, among other products, normal weight concrete, heavyweight concrete, lightweight concrete, high performance concrete, insulating concrete, pervious concrete, zero slump concrete, self-consolidating concrete, flowable fill, gunite, shotcrete, latex modified concrete, and mortar mix. It can produce colored concrete, fiber concrete, rapid setting concrete, roller compacted concrete, and any other type of concrete that can be produced by a concrete mixer. The presently described volumetric mixer can be a mobile concrete plant, capable of producing a continuous stream of concrete or cementitious materials.

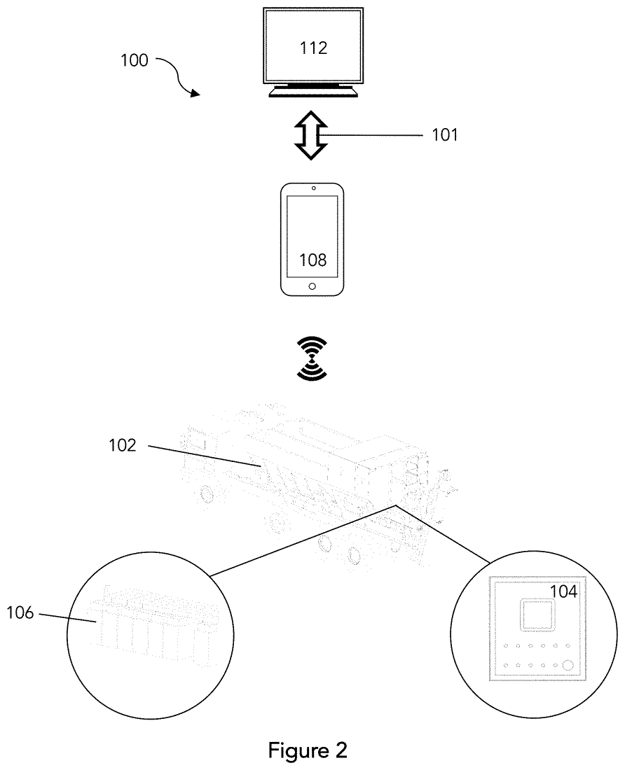

FIG. 2 illustrates an example volumetric mixer control system 100 and bidirectional communication between components in the system. Main components of the volumetric mixer control system 100 are the controller area network on the mobile volumetric mixer 102, a local mixer control system 104 comprising a programmable logic controller, a control bank 106 for controlling a plurality of electronic control units (ECUs) exemplified here as a hydraulic control bank, and mobile electronic device 108. A bi-directional communication link 101 connects the remote terminal 112 to the mobile electronic device 108, and the mobile electronic device 108 to the CAN bus system in the mobile volumetric mixer 102. On the remote terminal side, the bi-directional communication link 101 can comprise wi-fi and/or ethernet connectivity from the remote terminal to one or more servers (not shown), and/or to a cloud network or other communication and data storage and processing network. A long range wireless network enables communication between the remote terminal and the mobile electronic device, preferably through the one or more server, which can be any wireless communication network capable of reliably operating over long distances. Preferably this communication network is a cellular or satellite communication network, with appropriate hardware on the remote terminal 112 and the mobile electronic device 108 to send and receive signals and data. The communication network can also be directed through a cloud computing system, and the one or more server can optionally be a cloud-based server. Between the mobile electronic device 108 and the CAN bus on the mobile volumetric mixer 102, a shorter range wireless communication network can be used, such as, for example, bluetooth, wifi, or any other wireless technology for exchanging data over short distances such as personal area networks (PANs). Preferably, the mobile electronic device is a tablet, smartphone, or other smart electronic device capable of both short range and long range wireless communication.

The controller area network (CAN) on the mobile volumetric mixer 102, referred to herein as the CAN bus, comprises a wireless transceiver for connection between the CAN bus system and integrated components therein. Bidirectional communication within the CAN bus network can provide interaction between multiple subsystems of the volumetric mixer. The controller area network (CAN bus) is a robust wireless bus standard designed to allow microcontrollers and devices to communicate with each other in applications without a host computer. CAN bus uses a message-based protocol comprising a multi-master serial bus standard for connecting electronic control units (ECUs), also known as nodes, with two or more nodes required to communicate. CAN bus systems are used in passenger vehicles, trucks, buses, electronic equipment for aviation and navigation, industrial automation and mechanical control, elevators, escalators, building automation, medical instruments, and equipment to facilitate communication between servos and microcontrollers such as in prosthetic limbs. CAN standards are governed by the International Organization for Standardization (ISO) by ISO 11898-1 which covers the data link layer, ISO 11898-2 which covers the CAN physical layer for high-speed CAN, and ISO 11898-3 which covers the CAN physical layer for low-speed, fault-tolerant CAN. Society of Automotive Engineers standard SAE J1939 is the vehicle bus recommended practice used for communication and diagnostics among vehicle components. Each node in the CAN requires a central processing unit, a microprocessor or host processor for deciding what the received messages mean and what messages it wants to transmit, and a CAN controller for receiving and storing the received serial bits from the bus until an entire message is available which can then be fetched by the host processor (usually by the CAN controller triggering an interrupt). The host processor sends transmitted message(s) to the CAN controller, which transmits the bits serially onto the bus when the bus is free. A transceiver receives and converts the data stream from CAN bus levels to levels that the CAN controller uses and converts and transmits the data stream from the CAN controller to CAN bus levels. One or more sensors, actuators and control devices can be connected to the host processor. To put this system into context, a modern automobile may have as many as 70 electronic control units (ECU) for various subsystems. Typically the biggest processor is the engine control unit, but others are used for transmission, airbags, antilock braking (ABS), cruise control, electric power steering, audio systems, power windows, doors, mirror adjustment, battery and recharging systems for hybrid/electric cars. Other examples of CAN bus ECUs include auto start/stop, electric park brakes, parking assist systems, lane assist, collision avoidance systems, auto brake wiping, and a wide variety of sensors. Some of the ECUs form independent subsystems, and communications among others is essential. In particular, a subsystem may need to control actuators or receive feedback from sensors, and connections between multiple ECUs can provide greater connectivity, feedback, and control. One advantage of using a CAN bus system is that interconnection between different vehicle systems can allow a wide range of safety, economy and convenience features to be implemented using software alone, a functionality which would add cost and complexity if such features were hard wired using traditional automotive electrics. One alternative to CAN is LIN (Local Interconnect Network) which is a serial network protocol used for communication between components in vehicles. Preferably all interconnected components operating with the CAN bus technology are directly hard wired together where possible. In volumetric mixers, CAN systems can also have ECU nodes for controlling the local mixer control system 104, which controls a plurality of flow control devices through a control bank 106 for controlling a plurality of electronic control units. Some non-limiting examples of flow control devices include auger mixers, volumetric gates, gravimetric gates, pumps, motors, scales, servos, and other devices for controlling fluid flow during concrete mixing and delivery. ECU nodes in the CAN system in the volumetric mixer can also be used for sensing, for example, fluid levels and/or mass in reservoirs and hoppers, and sensing torque and rotation of mixing and transfer augers and mixers. Yet other ECU nodes in the CAN system can be used for component metering such as liquid or bulk solids, and for controlling flow rates through flow control devices such as, for example, pumps, valves, solids flow conveyors, augers, gates, and mechanical conveyance devices. Yet other ECU nodes can be used to control local temperature in one or more of the volumetric mixer components, reservoirs, bins, or hoppers, by adding or removing heat. Each ECU can be controlled using the CAN bus communication protocol.

Due to the added capabilities of wireless accessibility to the CAN bus system, each of the individual subsystems in the volumetric mixer can be contacted, queried, manipulated, and can be affected by an intermediate tool such as a cloud based logic, artificial intelligence (AI) logic, a dispatcher, a team leader, owner operator, or other stake holder. For example, a cloud based AI logic may be further integrated with sensors on board the mobile volumetric mixer to read the moisture content and gravimetric weights of materials being dosed into the mixing auger and automatically adjust both the mixer calibration settings and the solids and/or liquid flow characteristics dynamically while the mixer is producing chemicals remotely without interaction of the onsite operator. This would have the effect of increasing the overall output quality and the quality of the chemical composition that is being created. Alternatively, a team leader or skilled technician can access real time chemical or mix composition data and make adjustments to the mix design without needing to consult the onsite operator. One or more optional on-board cameras or LIDAR can further enable a remotely located team leader or skilled technician to be able to visually see the chemical composition prepared by the volumetric mixer via a still or video live feed stream and make adjustments to the mix design without needing to consult the onsite operator. A team leader or skilled technician or AI logic may also be enabled to detect variations in the hydraulic, pneumatic or electrical systems of the mixer and be able to make adjustments to the mix design and or mixer operations metrics without needing to consult the onsite operator.

The server can have saved information on the mixer, software and AI logic to assist with chemical composition ordering, delivery, data tracking, mixer configuration, troubleshooting, calibration, and dynamic mix recipe modifications based on real time information. The local mixer control system and mixer side communication through the communication network can be used to facilitate increased automation and bidirectional communication between the physical components of the volumetric mixer and a remotely located mix recipe control system. The communication network thus links the physical system of controls to operate the volumetric mixer with the software, database, and computer intelligence controls which act upon the mixer to manipulate the output characteristics based on a broad range of pour parameters. The local mixer control system 104 on the volumetric mixer is integrated with a centralized control centre to provide a communication and control strategy whereby the mixer can communicate in a real time, bidirectional way with remote technicians at a remote terminal 112 through the wireless communication network and the mobile electronic device 108. In one embodiment, the proximity of the mobile electronic device 108 held by the volumetric mixer operator can provide a handshake connection to not only relay control signals from the remote terminal 112 but also initiate operation of the mobile volumetric mixer 102. The presently described wireless technology merges aspects of near-field communication (NFC driver SSID chips for safety lockout), body area networks (BAN with wearable computers), personal area networks (PAN connecting the operators workspace components), near-me area network (NAN communicating of several system components not spatially located near each other), wireless local area networking (WLAN including wi-fi internet access points and communications between multiple assets at a jobsite or service facility), wide area networks (WAN for online access) and cloud based systems Internet area networks (IAN) for remote accessibility and control/configuration. The CAN bus can thereby be enabled to wirelessly communicate (via bluetooth, ble wi-fi, radio, etc) using appropriate hardware which connects to a mobile technology platform that can in turn communicate in real time with the internet, the cloud and technicians in remote locations. Special data management strategies can be further implemented so that packet loss associated with wireless interference is minimized and instantaneous bidirectional communication is reliable and robust. This technology is especially useful when considering mobile applications such as volumetric concrete mixers which may be required to produce very high-quality concrete in remote locations where a skilled operator is not available. The bidirectional communication network can allow and enable remote technicians to troubleshoot the operation of the mobile mixer, factoring variables such as temperature, elevation, GPS location, performance additives, ingredient variations, ambient humidity, weather, precipitation, desired strength, curing characteristics, and mixer functionality and function. Furthermore, this technology could allow a single remote technician to simultaneously oversee and control several small mixers in different remote locations, one single location or several mixers at a single unit.

The remote terminal 112 can be any computing device capable of relaying a mix recipe, such as, for example, any desktop, laptop, tablet, smartphone or smart electronic device with connectivity for connecting to the communication network. Operators can further be provided with a mobile application on the mobile electronic device 108 to assist them to stay on top of their assignments, allow the company to better manage concrete mixing and delivery, save time, and provide clarity to operators. In addition, features that may be accessible to the mobile electronic device 108 include but are not limited to parameter adjustment, calibration control, remote recipe setting, and remote delivery reporting. Alternatively, these controls may be only partially or entirely inaccessible to mixer operators and may be partially or entirely controlled via remote terminal 112. One or more job screens on the mobile electronic device 108 can also be provided with listing of jobs to be done and optionally link to a map. Any of a user interface on the local mixer control system 104, on the mobile electronic device 108, and on the remote terminal 112 may also provide the operator or technician with mixer system statistics, such as, for example, cement content, contents of hoppers, total weight of recipe, strength of recipe, or display the mix recipe. On the remote terminal 112 the operator can also optionally add additional information on a job by submitting a job report that may include job photos, a receipt or ticket, notes on the job, on site weather during the pour, add payment information for customer, or send a job report. Other features that may be controlled by the technician at the remote terminal 112 can include but are not limited to enabling viewing of previous orders from the customer, remote login by technician to add jobs, control recipes for each job, view operator progress or job status for each job for each mixer, view delivery results for each job, and view system status for each mixer. Recipes can be viewed, added, or modified by the technician at the remote terminal 112. The remote terminal can also be used for fleet management, mobile vehicle tracking, and remote vehicle diagnostics, optionally by extracting vehicle data through a CAN data logger on the mobile volumetric mixer. On the remote terminal 112 the operator can also optionally add additional information on a job by submitting a job report that may include job photos, a receipt or ticket, notes on the job, on site weather during the pour, add payment information for customer, or send a job report. Mobile payment technology can also be integrated such that order tickets can be invoiced and/or paid for using a connected financial transaction system.

The technology package described herein can ultimately enable an unskilled worker to be physically present at a remote jobsite location and create a specialized, highly accurate and highly consistent chemical composition that is far superior to that which could be created by the operator if working independently. By putting the technical parts of mix control and operation into the control of a remote trained technician at a remote central site, truck operators can focus on delivery of concrete and training level of on site operators can be lower. The unskilled worker may in essence only be responsible to ensure the safe operation of the mixer, or part of the mixer, and the delivery of the mixed composition without significant if any influence over the mixers raw material configurations and production characteristics. Furthermore, this technology can encompass a complete business solution controlling order taking, asset allocation, chemical delivery, chemical mix design and composition, invoicing, maintenance, calibration, troubleshooting, and delivery control. This business solution may also consist of a number of technologies and integrations thereof including but not limited to platform specific applications (Apps) for mobile devices, custom software installations, software as a service (SaaS) solutions, uploaded databases, voice to text instructions, email, verbal control, scanned and/or uploaded work sheets, etc. The system can also feature stored data that can be used to call or create mix designs in regions or situations where remote connectivity is not possible. Records of the chemical composition created by the mixer can also be printed or recorded using systems directly attached to the mixer for the purposes of on-the-job reporting or invoicing.

A protocol for calibration of the truck can also be provided to reduce the operator workload and provide additional information to the remote terminal. In one example, a material can be selected to be calibrated, i.e. cement, stone, sand. Instructions can be provided to the operator on the on the mobile electronic device 108 to guide the operator through the calibration. In one example, the operator can be instructed with the following sequence: “Notice to Operator: Before starting calibration notice to operator ensure that truck is on, PTO is engaged, and RPM engine speed is at operational setting of 1350 RPM”; and “prime cement auger before each clutch change to ensure proper measurements”. Once the start conditions are met, the operator can press START on the on the mobile electronic device 108 or the mixer user interface to calibrate the volumetric mixer. Calibrations for each mobile volumetric mixer 102 can be sent to the remote terminal 112 through the communication network such that calibration of each truck can be ordered and reported from a remote location. Mix designs and or parameters can be stored for later access at any node in the communications system. Should one node be damaged or not needed, the control system can skip a node as shown in FIG. 2.

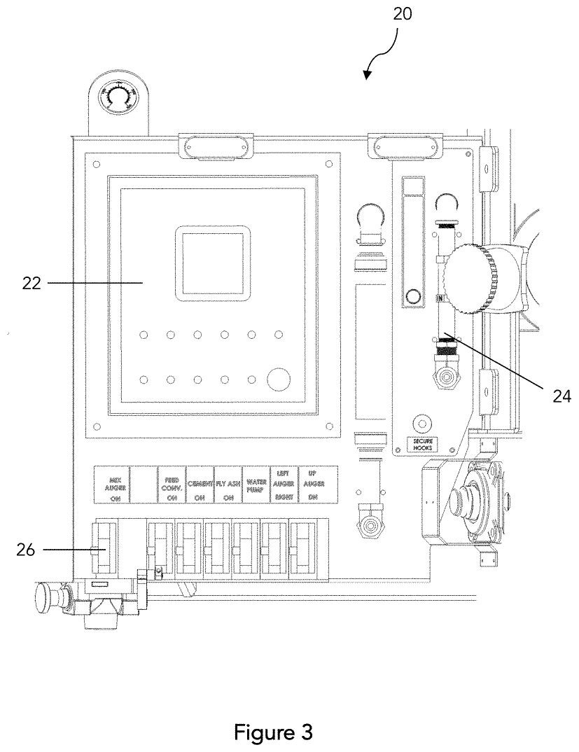

FIG. 3 illustrates a representative control panel for a mixer control system locally mounted to a volumetric mixer. The mixer control panel 20 is an HMI (Human Machine Interface) which features mixer user interface 22 for viewing mix designs and/or displaying mixer parameters, recipes, calibrations, etc. Digital control buttons are shown displayed on the user interface. Local mixer control system comprises a programmable logic computer (PLC) and display, which can comprise a screen, touchscreen, or any other display components. The programmable logic computer in the local mixer control system is capable of relaying information to and from the onsite operator from the individual components controlled by CAN bus technology. Transmitted information can pertain to, for example but not limited to, recipe designs (read and write), stored data (read and write), calibration data (read and write), gravimetric and or volumetric ingredient status, real time and/or current system performance, historical performance, etc. Interaction with the control panel may provide additional access to menus and/or configuration screens to access data (read and write) relating to specific CAN bus networked technologies. In one example, further information and control can be provided to access the water pump rate, water valve settings, admixture flow rates, and other flow control devices or sensors. The PLC may also provide multiple screens and/or settings for various types of uses (administrators vs operators) and may be customizable as required by the mixer. Optional fluid gauges 24 can be provided to give a visual fluid flow rate on a volumetric scale which can be used for the verification of critical fluids. The fluid gauges 24 can further be fit with levels or sensors to read, report, and/or record fluid levels and/or pressures. Electronic flow device controllers can be electronic actuated hydraulic valves connected to a hydraulic control bank. The presently shown system employs hydraulic controls to control the flow control devices, however other mechanisms known to the skilled person could be used, including electrical and electronic signalling. Manual override controls 26 can also be provided for local operators to conduct maintenance and configurations tasks. The manual override controls 26 can also be used to change the position of the flow control devices, the mix auger and/or other controls on the volumetric mixer. Other supplemental sensors can be connected to the controller including moisture sensors, temperature sensors and gravimetric weigh (load) cells. Other supplemental accessories such as aggregate coolers, aggregate heaters, water coolers, water heaters, etc. can also be integrated to further expand the functional capabilities of the volumetric mixer.

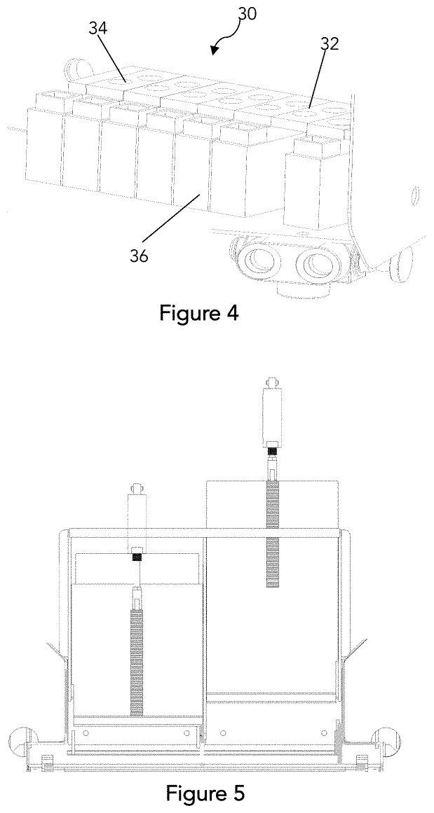

FIG. 4 shows the inside of a representative control box showing electro-hydraulic valves 32 and electronic solenoids 36 on a hydraulic valve bank 30. Electronic solenoids 36 are each electrically connected for power and signal to the PLC in the local mixer control system and control the flow to hydraulic valves 32 on the hydraulic valve bank and can be thought of as individual electronic control units that each control a flow control device in the mix control system. Each hydraulic valve 32 shown has an inlet and return for hydraulic fluid 34. The electronics can be controlled by the PLC, or receive offsite instructions from the remote terminal via the CAN bus communication systems and or wireless connectivity to WAN networks. Omitted from this image for clarity are the electrical wires, hydraulic hoses and pneumatic hoses that are connected to the individual subcomponents of the system. One preferable mode of implementation is to rely on hydraulic power for high torque components such as pumps and conveyors, pneumatics for safety latches, and electrical systems for detailed and/or fine control with potentially instantaneous response time.

FIG. 5 illustrates solids flow gates with controllable height adjustment capability. The flow gates are used to volumetrically control the flow rate of sand and gravel (aggregate) type solids as they are dosed into the mixing screw conveyor (auger) and calibrated. Flow gates are controlled here by flow control hydraulic or pneumatic cylinders. Omitted from this image is the lower mounted transfer belt conveyor that is typically used to control the flow of the primary solids to the mixing region of the system. The solids flow gates can be set to an infinitely adjustable position through the use of a linear actuator, such as an electro mechanical, hydraulic, or pneumatic actuator, optionally in conjunction with a position sensor. The gates represent a calibrated orifice in the aggregate storage bins. The ultimate position of the flow gates can be set or manipulated dynamically through the wireless CAN bus communication systems as previously described. FIG. 5 shows one gate more open than the other showing the capability of individually controllable solids flow rates with a uniform lower mounted conveyor belt speed. Such hydraulic gating systems for volumetrically controlling addition of aggregate components to the mix are controlled through the CAN bus system. A square-strike-off system for the sand and stone flow gates can further provide an accurately calibrated amount of material to the composition. Square strike off is defined as the shape of the aggregates on the feed conveyor as they leave the storage hopper and head toward the collecting funnel. The width of the flow gates is known, however the height of the gate is variable. The lower conveyor is flat and smooth and the lower gate geometry is known, and is preferably square with 90 degree corners such that the aggregate material that flows from the storage hopper is of a readily calculated volume and has been “square struck off”. The square strike off on top of the material flow makes the cross sectional area shape of the aggregates moving from the storage hopper on the feed conveyor very regular and rectangular for simplified volumetric calculations. The regular and rectangular flow of materials has a secondary benefit of making a blockage or partial blockage of the gate very obvious. In one example, if a large rock has blocked the sand gate opening the operator will see an irregular shape of material flowing in to the mixing auger rather than the expected square shape, thus signalling a fault that will affect mix design. Scanning sensors such as Light Detection and Ranging, also known as LIDAR, for example, can be used to continuously scan the shape of the materials flowing from the storage hopper to verify the volume of the material entering the mix auger. In use, LIDAR (Light Detection and Ranging) volume recordings can be used to adjust gate settings and moisture content and to calculate the mass of the aggregates in the mix and the mass of water that is entrapped in the solids entering the mixing auger. Preferably, the solids flow gates can be manually manipulated in the event of an automation failure or lack of automation.

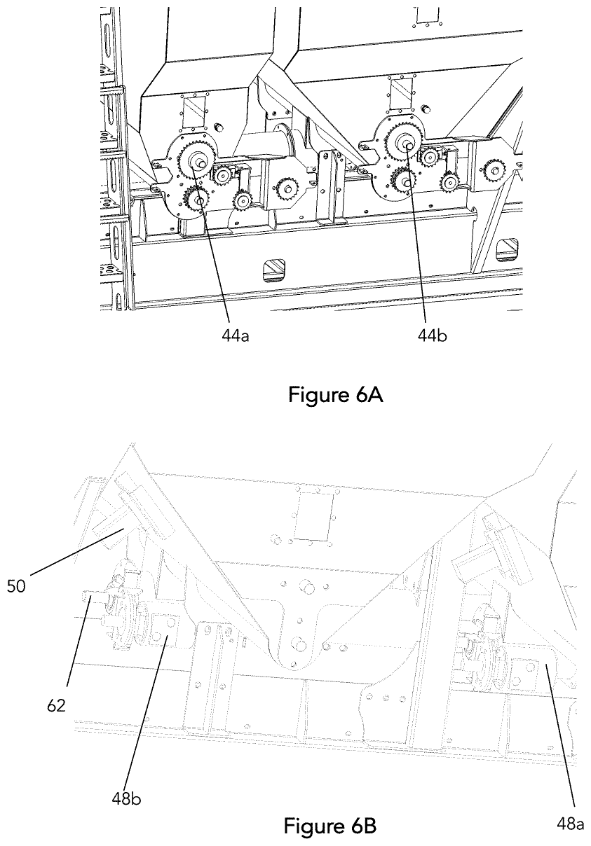

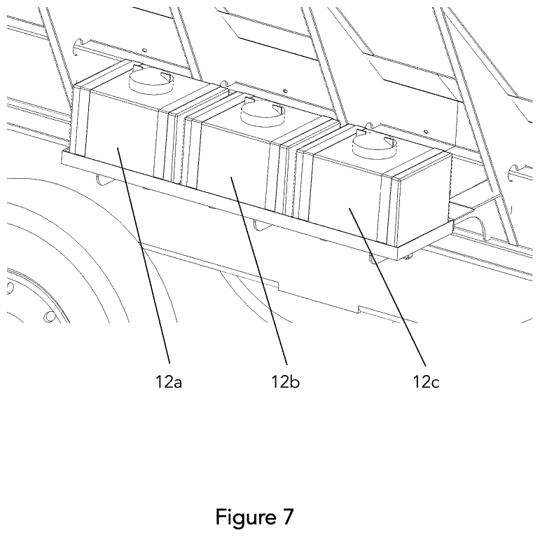

FIG. 6A illustrates independently powered powder additive silos to control the flow rate of powders into the concrete. Geared transfer augers 44a and 44b are screw feed conveyors that control the flow of cementitious material from a storage bin to standardize the volume or mass of material going into the mixture. Cement or powder metering can further be mechanically linked to the belt or auger delivering sand and stone, meaning that the most costly ingredient will be ratioed precisely and accurately. Multiple powder additives such as cements, pozzolanic materials, and supplementary cementitious materials (SCMs) can be added and multiple bin and transfer devices can be controlled to mount multiple, independently powered powder silos. Other flow control devices that can be used to meter solid powders include but are not limited to chain drives and transfer conveyors or belts. Other possible powder additives in addition to Portland cement and fly ash include but are not limited to powder colourants, powders for added texture modifiers, powders for aesthetic applications, etc. The dosing of these powders is preferably conducted by a series of screw conveyors or augers located at the bottom of the bins. The dosing screw conveyors are each individually powered and controllable with individual electronic control units through communication through the CAN bus system, with each of the two motors independent from each other and operational at different speeds from 0% to 100%. This will control the dosing of, for example, 0 to 30 kg/second of each of the powders into the chemical mix design. In one preferable example, individual hydraulic motors are controlled by an electrically actuated hydraulic flow circuit capable of dynamically varying the motors speed and torque.

FIG. 6B is a view of a side of a powder aggregate storage bin with two transfer augers and associated power and control systems. Powder silos can have secondary, independently powered dosing conveyors attached. In one example, a secondary dosing screw type conveyor is rigidly connected to a primary screw conveyor through a chain or gear box type gear system. A secondary dosing conveyor functions as a transportation system to deposit the powder in a specific location. In this case, one powder may sit and be compressed into the dosing conveyor (screw style) at one speed while the dosing screw delivers the powder at a specific density and/or rate of compaction or aeration at a different speed to the primary mixing part of the system. Auger motors 48a and 48b control transfer auger 62 and a drive auger connected to the reservoir or storage bin. Any powder aggregate storage bin can have one, two, three, or more auger screws with a corresponding auger motor for mixing cementitious material and for metered controlled volume addition. An optional vibrator 50 on the storage bin can assist with homogenizing the contents, modifying powder density, or breaking up clumps of material, and can also be controlled by the CAN bus. Each are individually powered and controllable through communication through the CAN bus system via hydraulic fluid input and return to the motor. Each of the motors is independent from each other and can operate at different speeds from 0% to 100%. This enables control of the dosing of 0 to 30 kg/second or more of each of the powders at a specific compaction density into the chemical mix design. In this example. In one preferable example, each individually controlled hydraulic motor is controlled by an electrically actuated hydraulic flow circuit capable of dynamically varying the motors speed and torque.

FIG. 7 is a perspective view of independently powered liquid additive storage tanks to control the flow rate of liquids. Liquid admixture reservoirs 12a, 12b and 12c are independently powered to control the flow rate of liquids into the mix. Each volumetric mixer can optionally have one or more than one liquid admixture reservoir to contain the secondary liquid chemical additives. These additives can be admixtures, performance additives, colours, for example (admixes, stabilizers, colour). Each liquid admixture reservoir is connected to a liquid admixture pump connected to the PLC to deliver the liquid admixture to the mixing chamber. In one example, liquid additives or admixtures are pumped from their respective reservoirs storage tanks through flow restricting valve to control the flow into the chemical mix design. Liquid admixture dosing pumps can operate at different speeds from 0% to 100% to control the dosing of 0 to 5 L/second and more of each of the secondary liquids into the chemical mix design. Non-limiting examples of pumps include rotary lobe, progressing cavity, rotary gear, piston, diaphragm, screw, gear, vane or peristaltic type. In one preferable example, each pump is an individually controlled, electric peristaltic type pump which is capable of metering, pumping and dosing the secondary liquid additives regardless head length or hose diameter.

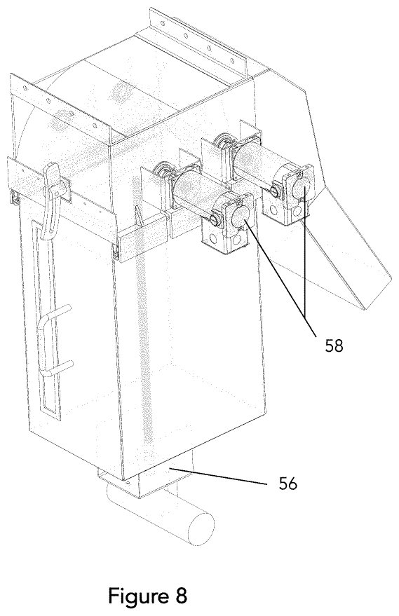

FIG. 8 is a perspective view of a powered fiber adder to control the flow rate of fiber additives into the volumetric mixer. A variety of fiber adders are possible for use, including chopper and disbursement style adders. Fiber additives can be of many types but are typically chopped or dosed into the chemical composition as required. A speed controllable electric thrasher 58 works to aerate and breakup precut fibers. A speed controllable electric plunger 56 mechanism supplies precut fibers to speed controllable electric thrasher 58. Speed controllable electric plunger 56 has a motor to raise the base of hopper fibers to position the fibers adjacent the speed controllable electric thrasher 58, where the fibers are expelled toward the chute. Each fiber feeding device is independent from each other and can operate at different speeds from 0% to 100%. This can control the dosing of 0 to 10 pounds/minute of each of the fiber additives into the chemical mix design. In this example, the fiber feeders can be electric choppers, pneumatic choppers or electric precut fiber dosing or pneumatic precut dosing. In one preferable example, an individually controlled, electric precut dosing fiber feeder or pneumatic chopper type fiber feeder is used.

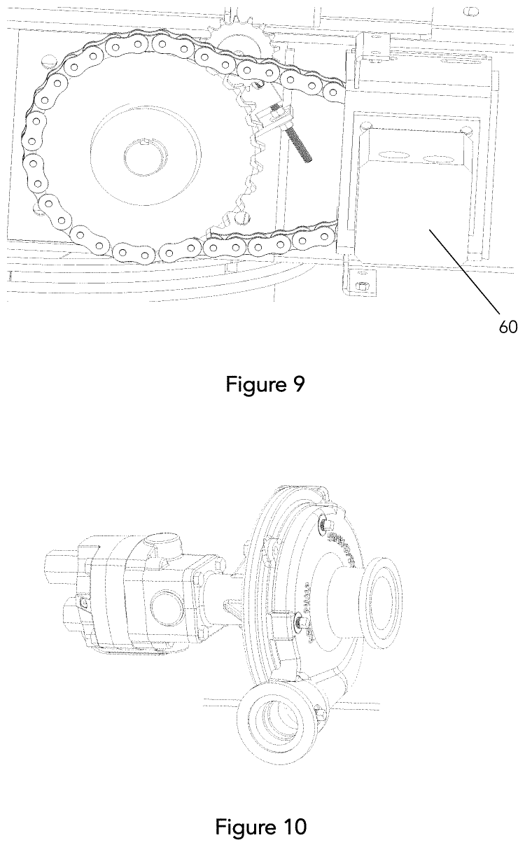

FIG. 9 is a front view a powered drive motor for drawing aggregate from a storage hopper. An independently powered drive motor is used for drawing sand and or gravel type aggregates from storage hoppers and powers a primary conveyor for drawing aggregates from storage bins drives live bottom belt, speed controlled by PLC. The motor 60, or any motor in the volumetric mixer can, for example, be a direct drive, gear box or gear/sprocket drive design, or any power transmission device desired depending on design torque requirements. It is possible that there are more than one lower or transfer conveyors depending of the design requirements of each specific volumetric mixer unit. Each conveyor can be independent from one another and can operate at different speeds from 0% to 100%. This will control the dosing of 0 to 200 pounds/second or more of each of the aggregate type ingredients. The transfer conveyors can be used to deliver secondary and tertiary type ingredients as well. In one preferable example, an individually controlled hydraulic motor controlled by an electrically actuated hydraulic flow circuit is capable of dynamically varying the motors speed and torque of each transfer conveyor. This motor can monitor its RPM and torque output and report the metric back through the CAN bus system.

FIG. 10 is an example of an independently controlled primary liquid or water pump. The pump can be electric, pneumatic, or hydraulic in nature. More than one primary liquid is possible depending on mix design. More than one pump in series or parallel is possible. Each pump is independent from each other and can operate at different speeds from 0% to 100%. These pump(s) will control the dosing of 0 to 10 L/second of each of the primary liquids into the chemical mix design. In this example, the pumps can be of rotary lobe, progressing cavity, rotary gear, piston, diaphragm, screw, gear, vane or peristaltic type. The best mode of implementation is shown as an individually controlled, hydraulic, variable speed centrifugal type pumps which are capable of metering, pumping and dosing the primary liquid additive through working in conjunction with a secondary metering system that is also controlled by CAN bus communication technology. This system is pneumatically powered, capable of on/off commands and secondary metering operations. The pump can monitor its RPM and torque output and report the metric back through the CAN bus system.

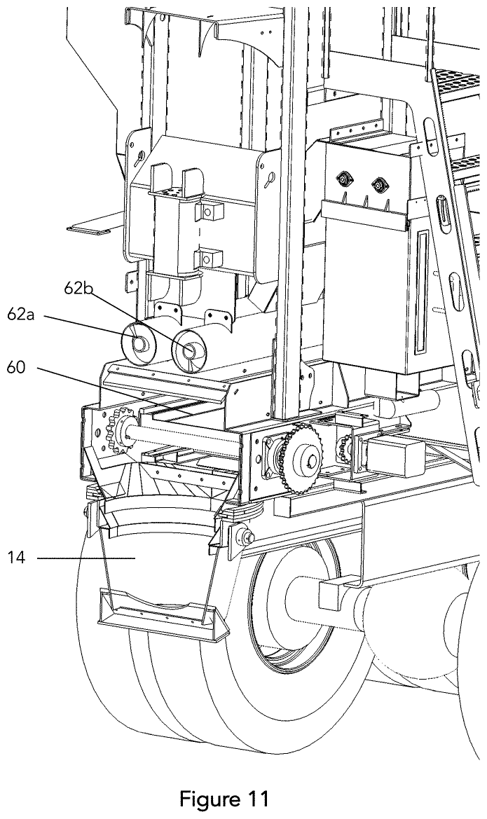

FIG. 11 is a cutaway view of the drop point of all the materials into the mixing bowl or funnel 14, before going into the mixing auger where the mix speed and fall back rate can be dynamically controlled. Transfer conveyors 60 that feed aggregate from the aggregate bins can be, for example, belt and or screw style. The discharge ends of transfer augers 62a and 62b discharges powdered material into mixing funnel 14 for mixing before all fed materials enter the mixing auger. A measurement tool such as LIDAR could be mounted here to inspect the materials flows into the mixing bowl.

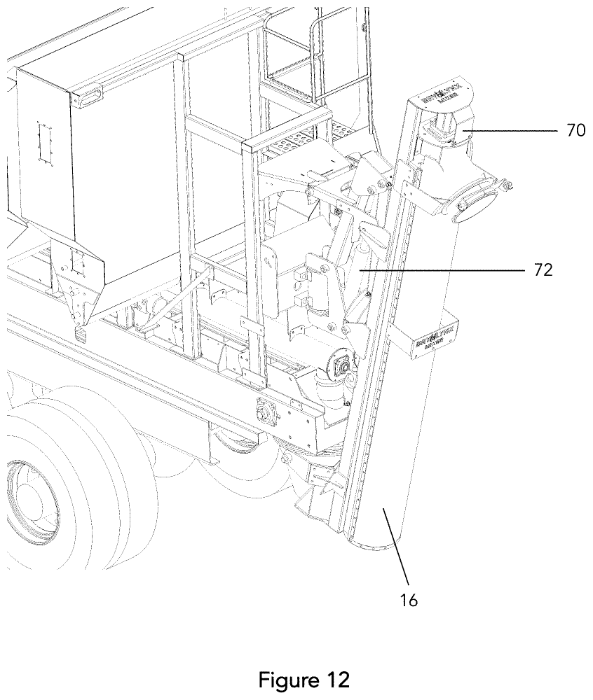

FIG. 12 is a view of a mixing auger and the discharge end of a volumetric mixer. Mixing auger motor 70 is used to rotate the mixing auger within its housing. Lift arm cylinder 72 that is used to control the angle of the mixing auger with respect to the ground. The mix auger can be adjusted up, down, left, right, rotated forward, rotated backwards, to aim the discharge end of the mix auger 16 as needed to control the outflow of cementitious products from the volumetric mixer. An optional rotary actuator can adjust the angle of boom/mixing auger with respect to the mixer center line. The angle of the mix auger 16 shown is in stowage position, however it is understood that for mix delivery the mix auger 16 angle will be closer to horizontal such that the outlet of the mix auger is adjacent to or near to the pour location. The mixing auger can comprise a number of mixing paddles and fall back regions that facilitate the mixing of the cementitious composition. The efficiency of the mixing auger can also be controlled by the angle of the mixing auger assembly. In one preferable embodiment, the mixing auger angle with respect to the ground, is adjustable from −25 degrees to +85 degrees. The mixing auger shown is a standard is 12-inch, high output mixing auger, however can be modified to provide the desired specifications, meet jobsite specific production, or meet mix characteristic requirements. The mixing auger can be rotated at a constant or variable speed and pressure as required. Added torque sensors on the mixing auger can provide real time feedback of the energy required to mix the chemical composition, which can be further used to determine quality characteristics of the cementitious composition. Communication through the CAN bus communication system can facilitate remote resources to read and interpret this information in real time which can result in composition changes and or changes to the mixing angle and or mixing speed of the mixer. The mix motor is independent from all dosing equipment and can operate at different speeds from 0% to 100%. This will control the final chemical mixing and discharge of 0 to 150 kg/second or more of each of the completed cementitious compositions. The lift arm cylinder 72 is independent from the mix motor and all dosing equipment and can operate from 0% to 100% extended. This can control the final composition mixing time depending on the angle from horizontal and speed of the mixing auger. In one preferable embodiment, an individually controlled hydraulic motor on the mix auger is controlled by an electrically actuated hydraulic flow circuit capable of dynamically varying the motors speed and torque and a hydraulic cylinder for the mixer angle, and is controlled by an electrically actuated hydraulic flow circuit capable of dynamically varying the cylinders extension length.

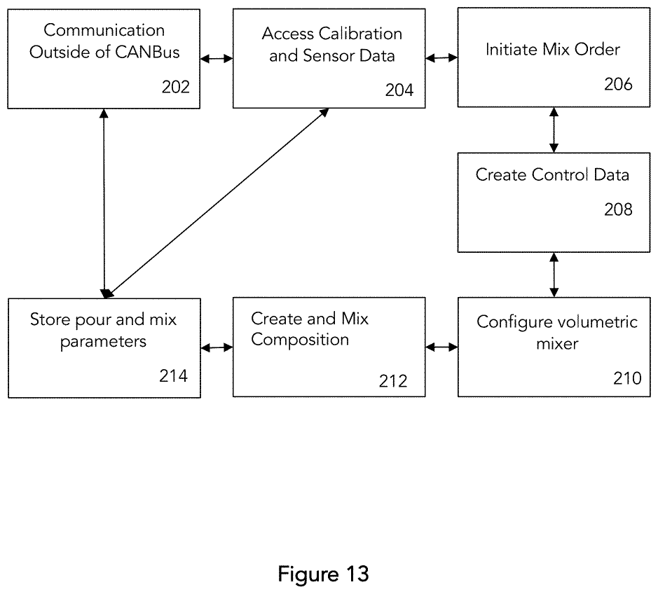

FIG. 13 illustrates a detailed communication dataflow in the mix control system. The figure highlights the bidirectional data transfer and communication between the various system components. Further highlighted is the computer logic for increasing mix accuracy through dynamic and continuous updates to the calibration benchmark data as required. The communications of this system comprise a complete circle and include dynamic feedback to external influences outside of the CAN bus system 202. Bi-directional communication outside of CAN bus occurs between the remote terminal and cloud or internet and mobile electronic device or direct contact with the PLC. To generate a recipe or mix, calibration and sensor data is accessed 204 and the mix order is initiated 206. To control the mixer from the remote terminal, control data is created 208 to control the volumetric mixer which instructs and configures the volumetric mixer 210. Once the mixer is configured, the mix composition is created 212 and the volumetric mixer creates and mixes the composition 212. The pour and mix parameters are then stored 214 in a central location external to the volumetric mixer, optionally in the cloud, and at a location that is at or accessible to the remote terminal. Stored pour and mix parameters 214 also take into account the calibration and sensor data to create the recipe and initiate the mix order 206.

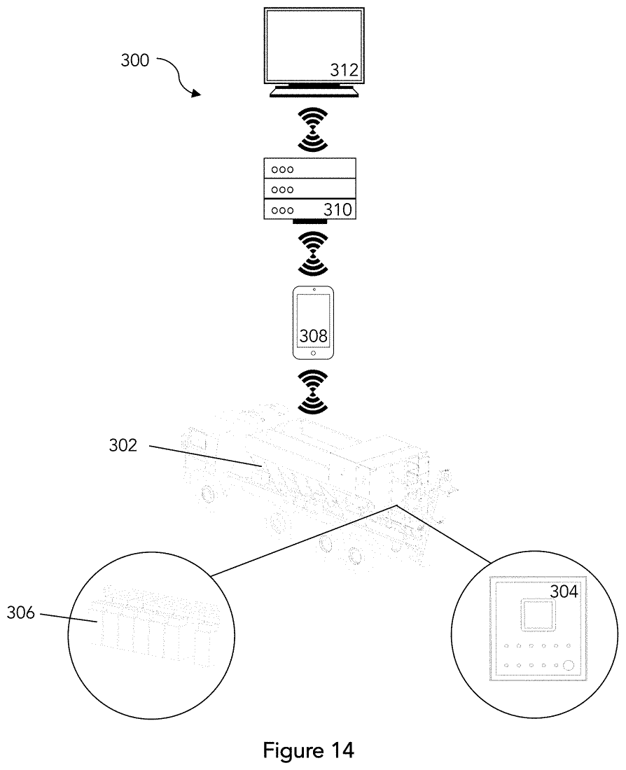

FIG. 14 illustrates an alternate example volumetric mixer control system 300 and bidirectional communication between components in the system. Main components of the volumetric mixer control system 300 are the controller area network on the mobile volumetric mixer 302, a local mixer control system 304, hydraulic control bank 306, server 310, and mobile electronic device 308. A communication network connects the remote terminal 312 to the server 310, the server 310 to the mobile electronic device 308, and the mobile electronic device 308 to the CAN bus in the mobile volumetric mixer 302. On the remote terminal side, the communication network can be comprises of wi-fi and ethernet connectivity to the server, optionally through the internet. Between the server 310 and mobile electronic device 308, a long range wireless network is required, such as any wireless communication network capable of reliably operating over long distances. Other features of the system are similar to those previously described.

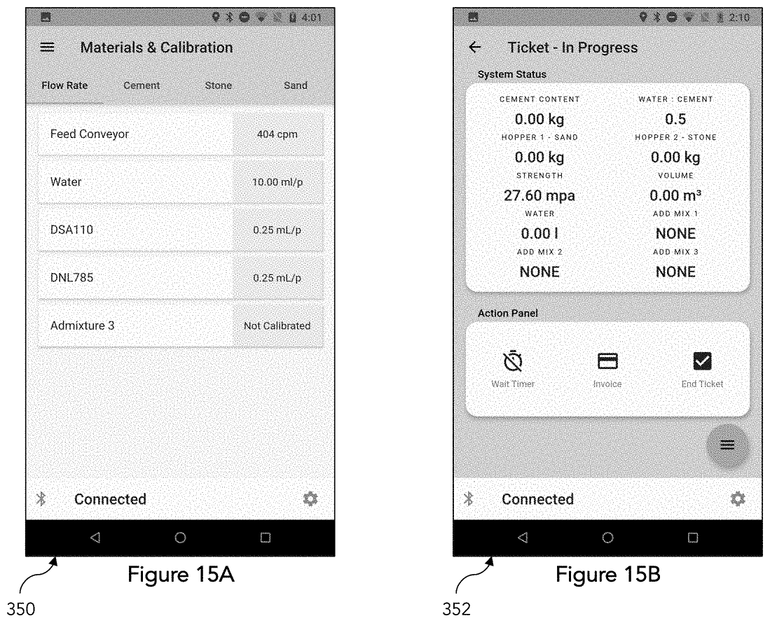

FIGS. 15A and 15B are example graphical user interfaces for a mobile electronic device. FIG. 15A illustrates a graphical user interface showing the calibration of various electronic control units, flow control units, containers and reservoirs on a mobile volumetric mixer 350. FIG. 15B illustrates a graphical user interface showing a ticket for a particular admixture order on a mobile volumetric mixer 352. Customers can use the application to order chemicals, receive chemical composition mix design recommendations (to help with knowing what to order), request job locations, request delivery options, times and locations etc., and details of orders can be viewed and modified. Customers can also be enabled to access similar data through the same or different application on a customer view on an internet enabled device. Operators can use the application on the mobile electronic device to see jobs lists, job maps, job descriptions, en route information when traveling to the job site, job status, billing or invoicing, system statistics, calibration information, instantaneous mixer information and other information pertinent to the mobile volumetric mixer and its operation. Operators can also use the interface on the mobile electronic device to review job ticket requirements, review upcoming jobs, be offered and accept jobs, and review job details including but not limited to mix type, customer, job location, job requirements such as time required and job details, The mobile electronic device can also be used to identify the job manager and obtain a signature for the mix delivered and for job completion. Details of the job including completion status and related information can be synchronized on an immediate or regular basis to the remote terminal so that a remote operator can monitor operation and status of the mobile volumetric mixer.

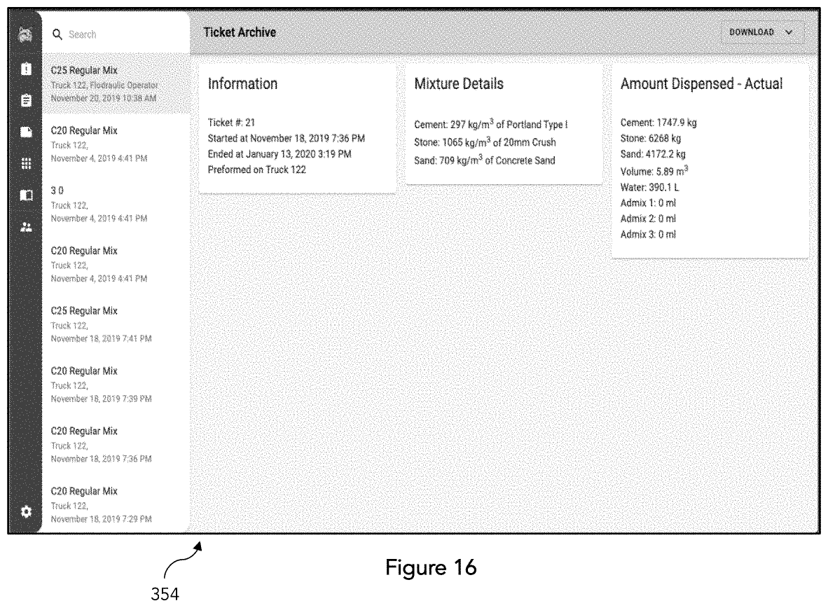

FIG. 16 is an example graphical user interface for a remote terminal 354. Dispatchers and stake holders can see information relating the mixer asset, information specific to the jobsite, and jobs lists, etc. The remote terminal application on the remote terminal can provide control over all aspects of the operation of the volumetric mixer from customer to operator. Remote operators and mix specialists can use the remote terminal interface to review the status of the mobile volumetric mixer, job status, environmental conditions at the job site, customer order, order specifications, mobile volumetric mixer calibration, material specifications, and other information that assist in setting the mixture and ordering the ticket. Customers can also be enabled to use the remote terminal interface to log into the system and their profile, order chemicals, receive chemical composition mix design recommendations (to help with knowing what to order), request job locations, request delivery options, times and locations etc.

Bidirectional data flow can be enabled between several nodes in the overall system. Routing can also be enabled in the control system for a remotely located computer system operated by a stakeholder to directly manipulate physical components and flow control devices on the mixer. In return, sensors on the mixer can report live information such as, for example, cylinder position or applied force from a pneumatic cylinder, back to the stakeholder at the remote terminal. Both communications can be completed through traveling through various communications networks (public and private). Features which may also be controlled by the remote terminal in the present system include but are not limited to GPS tracking of the volumetric mixer, batch tracking, mixer calibration, accounting, receipts and invoice generation, customer database tracking, mix design selection, slump manipulation, training resources, dynamic mix design changes, mix design verification, automated gate settings, mass measurement, automated fluid flow rates, pump speed changes, gate height settings, admixture on/off adjustment, fiber on/off adjustment, cementitious material dose rate adjustment, cement aeration, feed conveyor speed adjustment, solids flow rates adjustment, data collection from sensors, feedback to sensor input, weather information integration, weather sensors, use of CAN Bus technology to communicate with electrical sub components on mixer, gravimetric input/output, link of multiple mixer units, remote diagnosis of mixer problems, remote compensation control for mixer problems, remote monitoring of ingredient quantities, remote monitoring of mixer system health, temperature control of aggregates and base materials, manipulation of cement hydration, manipulation of composition workability, maximization of alite and belite crystal formulation, manipulation of trapped air, detection of faults, detection of blockage in mixer, and automated mix design and calculation using a variety of methods.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

1. A mobile volumetric mixer control system comprising:
a local mixer control system on the mobile volumetric mixer comprising:
a plurality of electronic control units for controlling a plurality of flow control devices;
a programmable logic controller in electronic communication with the plurality of electronic control units;
a transceiver for wireless communication; and
a controller area network for communicating with the plurality of electronic control units;
a mobile electronic device comprising a transceiver for local wireless communication with the controller area network;
a remote terminal for providing a control signal to the mobile electronic device to control the mix produced by the volumetric mixer; and
a communication link for bi-directional communication between the remote terminal and the mobile electronic device.

2. The control system of claim 1, wherein at least one of the plurality of electronic control units controls a hydraulic valve, pneumatic valve, or electromechanical actuator.

3. The control system of claim 1, wherein the programmable logic controller stores at least one mix recipe.

4. The control system of claim 1, wherein the programmable logic controller stores calibration data for the volumetric mixer.

5. The control system of claim 1, wherein the plurality of flow control devices are selected from augers, volumetric gates, gravimetric gates, valves, conveyors, gas pumps, scales, and liquid pumps.

6. The control system of claim 1, further comprising at least one sensor in communication with the controller area network.

7. The control system of claim 6, wherein the sensor detects at least one of auger torque, feed conveyor torque, gate settings, mass, material flow rates, oil temperature, vibration, external temperature, external humidity, ingredient temperatures, external weather, volumetric mixer location, and ingredient moisture content.

8. The control system of claim 1, wherein the remote terminal is a desktop, laptop, tablet, smartphone, or smart electronic device.

9. The control system of claim 1, wherein each of the plurality of flow control devices is a volumetric control device or a gravimetric control device.

10. The control system of claim 1, wherein the communication link is a cellular network or a satellite communication network.

11. The control system of claim 1, wherein the mobile electronic device is a tablet, smartphone, or smart electronic device.

12. A method of controlling a mobile volumetric mixer, the method comprising:
formulating a mix recipe at a remote terminal;
generating control data to control the mobile volumetric mixer for the mix recipe;
sending the control data to a mobile electronic device;
sending the control data from the mobile electronic device to the mobile volumetric mixer; and
creating a mix composition at the mobile volumetric mixer per the mix recipe.

13. The method of claim 12, further comprising accessing calibration data on the volumetric mixer and adjusting the mix recipe based on the calibration data.

14. The method of claim 12, further comprising accessing sensor data and adjusting the mix recipe based on the sensor data.

15. The method of claim 12, wherein the sensor data comprises at least one of auger torque, feed conveyor torque, gate settings, mass, material flow rates, oil temperature, vibrations, external temperature, external humidity, ingredient temperatures, external weather, GPS location, and ingredient moisture content.

16. The method of claim 12, wherein the pour parameters comprise at least one of volumetric mixer temperature, elevation, volumetric mixer location, performance additives, ingredient variations, ambient humidity, weather, precipitation, desired strength, curing characteristics, and mixer functionality and function.

17. The method of claim 12, further comprising using machine learning to optimize the mix recipe.

18. The method of claim 12, wherein the mix recipe is updated during the course of creating the mix composition.

19. A volumetric mixer comprising:
an aggregate reservoir with an aggregate flow control device;
one or more primary fluid reservoirs with a flow control valve;
one or more cementitious material reservoirs with a material flow control device;
a mixer control system comprising:
a plurality of electronic control units for controlling a plurality of flow control devices;
a programmable logic controller in electronic communication with the plurality of electronic control units;
a transceiver for wireless communication with a mobile electronic device; and
a controller area network for communicating with the plurality of electronic control units;
wherein the mobile electronic device provides a control signal to the controller area network to control the mix produced by the volumetric mixer.

20. The volumetric mixer of claim 19 wherein the mobile electronic device is mountable on the volumetric mixer.
